(19) United States
(12) Patent Application Publication
(10) Pub. No.: US 2018/0364630 A1
(43) Pub. Date: Dec. 20, 2018

(54) IMAGE FORMING APPARATUS AND NON-TRANSITORY COMPUTER READABLE MEDIUM

(71) Applicant: FUJI XEROX CO., LTD., Tokyo (JP)

(72) Inventors: Makoto HAMATSU, Kanagawa (JP); Hiroaki KUMAI, Kanagawa (JP)

(73) Assignee: FUJI XEROX CO., LTD., Tokyo (JP)

(21) Appl. No.: 15/915,689

(22) Filed: Mar. 8, 2018

(30) Foreign Application Priority Data
Jun. 19, 2017 (JP) 2017-119585

(51) Int. Cl. G03G 15/00

(52) U.S. Cl. CPC G03G 15/5062; G03G 15/065; G03G 15/0105; G03G 15/0266

(57) ABSTRACT

An image forming apparatus includes plural image preparing units whose attachment positions are selectable and that prepare images of respective colors; and a setting unit that, in a case where an attachment position of a first image preparing unit, which is any one of the plural image preparing units, is changed from a first attachment position to a second attachment position different from the first attachment position, sets, for the first image preparing unit in the second attachment position, first setting information that is different from first setting information set for the first image preparing unit while the first image preparing unit is attached in the first attachment position and second setting information that is identical to second setting information set for the first image preparing unit while the first image preparing unit is attached to the first attachment position.

### CROSS-REFERENCE TO RELATED APPLICATIONS

This application is based on and claims priority under 35 USC 119 from Japanese Patent Application No. 2017-119585 filed Jun. 19, 2017.

### BACKGROUND

### (i) Technical Field

The present invention relates to an image forming apparatus and a non-transitory computer readable medium.

### (ii) Related Art

An image forming apparatus includes plural image forming units that form images of respective colors of toner and forms a user image having a designated color by using the toner of the colors.

The image forming units are arranged along a transporting direction of an intermediate transfer body or a recording medium on which an image is to be formed, but positions of the image forming units are sometimes changed as needed.

Although the image forming units form an image on the basis of various kinds of setting information, the setting information to which the image forming units refer after the change of the positions of the image forming units also need be changed.

However, the setting information sometimes includes information that cannot be determined on the basis of only the positions of the image forming units. Therefore, in a case where the setting information referred to by the image forming units is determined on the basis of only the positions of the image forming units, quality of an image formed by the image forming units after the change of the positions of the image forming units sometimes becomes lower than an image formed by the image forming units before the change of the positions of the image forming units.

### SUMMARY

According to an aspect of the invention, there is provided an image forming apparatus including plural image preparing units whose attachment positions are selectable and that prepare images of respective colors; and a setting unit that, in a case where an attachment position of a first image preparing unit, which is any one of the plural image preparing units, is changed from a first attachment position to a second attachment position different from the first attachment position, sets, for the first image preparing unit in the second attachment position, first setting information that is different from first setting information set for the first image preparing unit while the first image preparing unit is attached in the first attachment position and second setting information that is identical to second setting information set for the first image preparing unit while the first image preparing unit is attached to the first attachment position.

### BRIEF DESCRIPTION OF THE DRAWINGS

Exemplary embodiments of the present invention will be described in detail based on the following figures, wherein:

FIG. 1 is a side view schematically illustrating an example of a configuration of a substantial part of an image forming apparatus;

FIG. 2 illustrates an example of a configuration of a substantial part of an electric system of the image forming apparatus;

FIG. 3 is a flowchart illustrating an example of a flow of a parameter storing process;

FIG. 4 is a flowchart illustrating an example of a flow of a parameter setting process;

FIG. 5 is a schematic view for explaining parameter storing and setting in the image forming apparatus according to a first exemplary embodiment;

FIG. 6 is a schematic view for explaining parameter storing and setting in an image forming apparatus according to a second exemplary embodiment; and

FIG. 7 is a schematic view for explaining parameter storing and setting in an image forming apparatus according to a third exemplary embodiment.

### DETAILED DESCRIPTION

Exemplary embodiments will be described below with reference to the drawings. Constituent elements and processes having identical functions are given identical reference signs in all of the drawings, and repeated description thereof is omitted.

As for expressions of colors, yellow, magenta, cyan, black, white, and transparent (clear) are expressed as “Y”, “M”, “C”, “K”, “W”, and “CR”, respectively. Furthermore, among colors that contain a metallic pigment and exhibit a metallic luster, gold and silver are expressed as “G” and “Si”, respectively.

In a case where members and images need be distinguished from one another on the basis of colors thereof, the color signs (Y, M, C, K, W, CR, G, and Si) corresponding to the respective colors are suffixed to names and reference signs thereof. Meanwhile, in a case where members and images need not be distinguished from one another on the basis of colors thereof, the color signs suffixed to names and reference signs thereof are omitted.

### First Exemplary Embodiment

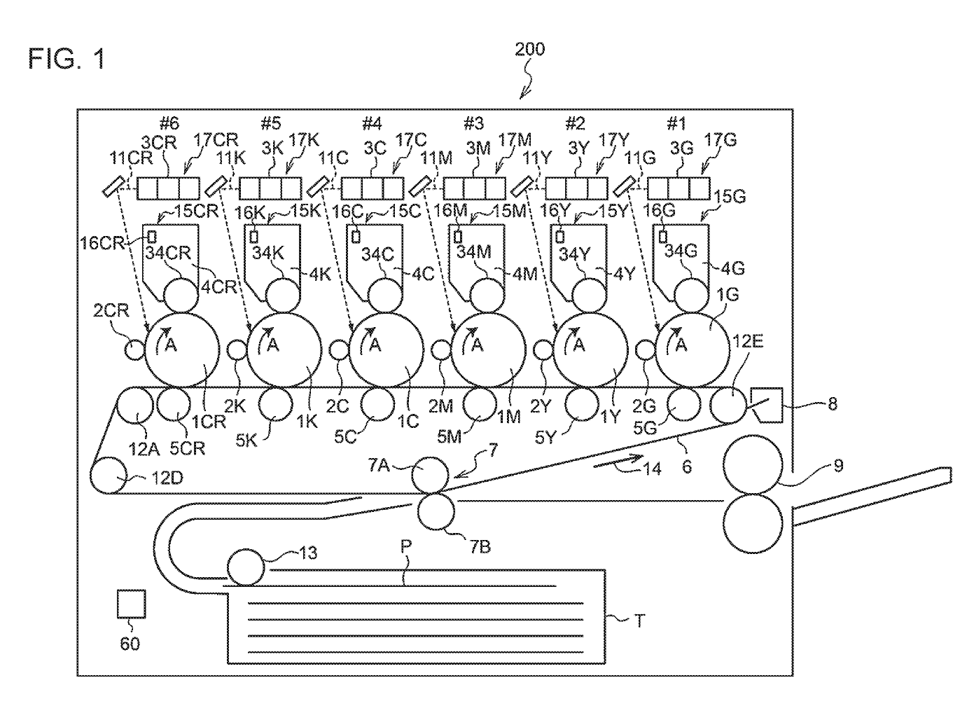

FIG. 1 illustrates an example of a side view schematically illustrating a configuration of a substantial part of an image forming apparatus 200 using an electrophotographic system. The image forming apparatus 200 has an image forming function of receiving image data, for example, through a communication line (not illustrated) and forming a user image based on the received image data on a recording medium such as a sheet of paper.

The image forming apparatus 200 includes, for the respective colors G, Y, M, C, K, and CR, six photoconductors 1G, 1Y, 1M, 1C, 1K, and 1CR that rotate in a direction indicated by arrows A in FIG. 1 and charging units 2G, 2Y, 2M, 2C, 2K, and 2CR that charge surfaces of the respective photoconductors 1 by supplying charging biases.

Furthermore, the image forming apparatus 200 includes laser output units 3G, 3Y, 3M, 3C, 3K, and 3CR that form electrostatic latent images on the photoconductors 1 by exposing the charged surfaces of the photoconductors 1 to light modulated on the basis of image information of the respective colors, and development rollers 34G, 34Y, 34M, 34C, 34K, and 34CR onto which developers (toner) of corresponding colors are attached and make contact with the respective photoconductors 1 while rotating.

Developing units 4G, 4Y, 4M, 4C, 4K, and 4CR supply toner to the development rollers 34 of the corresponding colors, cause the toner attached to the development rollers 34 to electrostatically adhere to electrostatic latent images by supplying developing biases (also referred to as “developing potentials”) to the respective development roller 34 from a power source for developing bias (not illustrated), develop the electrostatic latent images by using the toner of the respective colors, and thus form toner images (hereinafter simply referred to as “images”) onto the photoconductors 1. Note that the toner is stored in toner cartridges (not illustrated) prepared for the respective colors, and a controller 60 controls a dispense unit (not illustrated) to supply the toner stored in the toner cartridges to the developing units 4 of the corresponding colors so that toner concentrations in the developing units 4 become specified values while referring to output values of detection sensors 16 (also referred to as auto toner concentration (ATC) sensors 16) that detect toner concentrations in the developing units 4.

Furthermore, the image forming apparatus 200 includes first transfer units 5G, 5Y, 5M, 5C, 5K, and 5CR that transfer images of the respective colors formed on the photoconductors 1 onto the intermediate transfer belt 6 that is an example of a transfer body.

Furthermore, the image forming apparatus 200 includes a paper container T in which a sheet of paper P that is an example of a recording medium is contained, a second transfer unit 7 that transfers an image on the intermediate transfer belt 6 onto the sheet of paper P, a fixing unit 9 that fixes the image transferred on the sheet of paper P onto the sheet of paper P, and a belt cleaner 8 that removes toner remaining on a surface of the intermediate transfer belt 6 after the image is transferred onto the sheet of paper P by the second transfer unit 7.

Furthermore, the image forming apparatus 200 includes a cleaner (not illustrated) that cleans surfaces of the respective photoconductors 1 and an eliminator (not illustrated) that removes an electric charge remaining on the surfaces of the photoconductors 1.

Members of the image forming apparatus 200 that are related to development of an electrostatic latent image using toner of a predetermined color, such as the toner cartridge (not illustrated) in which toner of any of the colors is stored, the dispense unit (not illustrated) that transports toner, the detection sensor 16 that detects a toner concentration, the developing unit 4, and the development roller 34 are sometimes collectively referred to as an “image preparing unit 15”. That is, the image preparing unit 15 is an example of an image preparing unit.

Members of the image forming apparatus 200 that are related to formation of an image to be transferred onto a transfer body, such as the photoconductor 1, the charging unit 2, the laser output unit 3, and the image preparing unit 15 operate in cooperation with one another and constitute an example of the image forming unit 17 that forms an image on the intermediate transfer belt 6.

Note that the members included in the image preparing unit 15 illustrated above are examples, and members included in the image preparing unit 15 are not limited to the members described above.

For example, in a case where a reserve tank for storing toner so that image preparation is continued even in a case where the toner cartridge becomes empty is provided in the image forming apparatus 200, the reserve tank is also included in the image preparing unit 15. Furthermore, the photoconductor 1 may be included in the image preparing unit 15.

The image preparing units 15 are attachable and detachable to and from the image forming apparatus 200. For example, the image preparing units 15 are selected in accordance with colors used for a user image, and the order in which the selected image preparing units 15 are arranged can be freely changed among attachment positions expressed as #1 through #6.

Although an image preparing unit 15G, an image preparing unit 15Y, an image preparing unit 15M, an image preparing unit 15C, an image preparing unit 15K, and an image preparing unit 15CR are attached in this order from an upstream side to a downstream side in a transport direction of the intermediate transfer belt 6 in the example of FIG. 1, attachment positions of the image preparing units 15 are not limited to these. Furthermore, although six image forming units 17 are provided in the example illustrated in FIG. 1, the number of image forming units 17 is not limited. That is, the attachment positions of the image preparing units 15 are not limited to the six attachment positions #1 through #6.

In the image forming apparatus 200, change of colors of images prepared by the image preparing units 15 need not necessarily be permitted in all of the attachment positions.

For example, since a color of a user image is often realized, for example, by a combination of toner of YMCK that is an example of chromatic toner of process colors that contain no metallic pigment, frequency of use of the image preparing units 15 for preparing images of process colors tends to be higher than that of the image preparing units 15 for toner of spot colors in formation of a user image. The spot-color toner is at least one of toner of W, toner of CR, and toner (e.g., G and Si) containing a metallic pigment. Since spot-color toner is used, for example, to express a color that is hard to achieve by a combination of process colors and is used for decoration, base, and coating of a user image, a color of spot-color toner necessary for formation of a user image sometimes need be changed depending on the user image.

Therefore, the image forming apparatus 200 may be configured such that the attachment positions of the image preparing units 15 corresponding to the process colors are fixed and change of the attachment positions of the image preparing units 15 corresponding to spot-color toner is permitted.

Each of the image preparing units 15 prepares an image by referring to setting information (hereinafter referred to as “parameters”) that is predetermined information concerning image preparation and includes information determined by a combination of an attachment position of the image preparing unit 15 and a color of an image prepared by the image preparing unit 15 (hereinafter referred to as a “color of toner of the image preparing unit 15”) and information determined by members accompanying the image preparing unit 15 irrespective of the attachment position of the image preparing unit 15, as described later.

Specifically, the parameters include information that is referred to in order to suppress occurrence of a defective image such as toner fog or void in a formed user image. Such a defective image is also called an “image defect”.

In a case where an attachment position of any of the image preparing units 15 is changed, the image forming apparatus 200 sets parameters referred to by the image preparing unit 15 after the change of the attachment position again and thereby suppresses occurrence of an image defect in a formed user image.

Next, an image forming operation in the image forming apparatus 200 illustrated in FIG. 1 is described.

First, for example, image data corresponding to a user image to be formed is supplied from an external device such as a personal computer (not illustrated) to the image forming apparatus 200 through a communication line (not illustrated).

Upon receipt of the user image, the image forming apparatus 200 negatively charges the surfaces of the photoconductors 1 by supplying charging biases to the charging units 2.

The user image is supplied to the controller 60 of the image forming apparatus 200. The controller 60 separates the received user image into pieces of image data that correspond to color components of toner of the attached image preparing units 15 and then supplies modulation signals based on the pieces of image data for the respective colors to the laser output units 3 of the corresponding colors. The laser output units 3 output laser beams 11 modulated in accordance with the modulation signals thus supplied.

The surfaces of the photoconductors 1 are irradiated with the modulated laser beams 11. Although the surfaces of the photoconductors 1 have been negatively charged by the charging units 2, irradiation of the surfaces of the photoconductors 1 with the laser beams 11 eliminates electric charges in portions irradiated with the laser beams 11, and as a result, electrostatic latent images corresponding to the pieces of image data for the respective colors are formed on the respective photoconductors 1.

The developing units 4 for the respective colors have negatively charged toner of G, Y, M, C, K, and CR and the development rollers 34 that attach the toner onto the surfaces of the photoconductors 1.

When the electrostatic latent images formed on the photoconductors 1 that are driven to rotate reach the development rollers 34, developing biases are supplied to the development rollers 34 by the power source for developing bias (not illustrated). This causes the toner of the respective colors attached to the peripheral surfaces of the development rollers 34 to be attached to the electrostatic latent images on the photoconductors 1 of the corresponding colors, thereby forming images corresponding to the pieces of image data for the respective colors on the respective photoconductors 1.

Furthermore, rollers 12A, 12D, and 12E and a backup roller 7A of the second transfer unit 7 are rotated by a motor (not illustrated), and thereby the intermediate transfer belt 6 is moved in a direction indicated by arrow 14 and is pressed against the photoconductors 1 at respective nip parts formed by the first transfer units 5 and the photoconductors 1. At this timing, first transfer biases are supplied from a first transfer bias power source (not illustrated) to the first transfer units 5, and thus the toner images of the respective colors formed on the photoconductors 1 are transferred onto the intermediate transfer belt 6 (first transfer).

From the surfaces of the photoconductors 1 from which the toner images have been transferred onto the intermediate transfer belt 6, an attached material such as remaining toner attached to the surfaces of the photoconductors 1 is removed by a cleaner (not illustrated), and a remaining electric charge is removed by an eliminator (not illustrated).

The second transfer unit 7 includes the backup roller 7A and a second transfer roller 7B that suspend the intermediate transfer belt 6 in a tensioned state, and the second transfer roller 7B makes contact with the intermediate transfer belt 6 and rotates so as to follow the movement of the intermediate transfer belt 6.

Furthermore, a sheet transfer roller 13 is rotated by a motor (not illustrated), and thereby the sheet of paper P contained in the paper container T is transported to a second transfer nip part formed by a pair of second transfer rollers, i.e., a combination of the backup roller 7A and the second transfer roller 7B of the second transfer unit 7.

When the sheet of paper P is pressed against the intermediate transfer belt 6 in the second transfer nip part in a state where the sheet of paper P faces a surface of the intermediate transfer belt 6 on which the image is formed, a second transfer bias is supplied to the pair of second transfer rollers from the second transfer bias power source, and thus the image formed on the intermediate transfer belt 6 is transferred onto the sheet of paper P (second transfer). The image thus transferred onto the sheet of paper P, i.e., a user image is heated and pressed by the fixing unit 9 and is thus fixed onto the sheet of paper P.

From the surface of the intermediate transfer belt 6 from which the toner image has been transferred onto the sheet of paper P, an attached material such as remaining toner attached to the surface of the intermediate transfer belt 6 is removed by the belt cleaner 8.

In this way, the user image is formed on the sheet of paper P, and the image forming operation is finished.

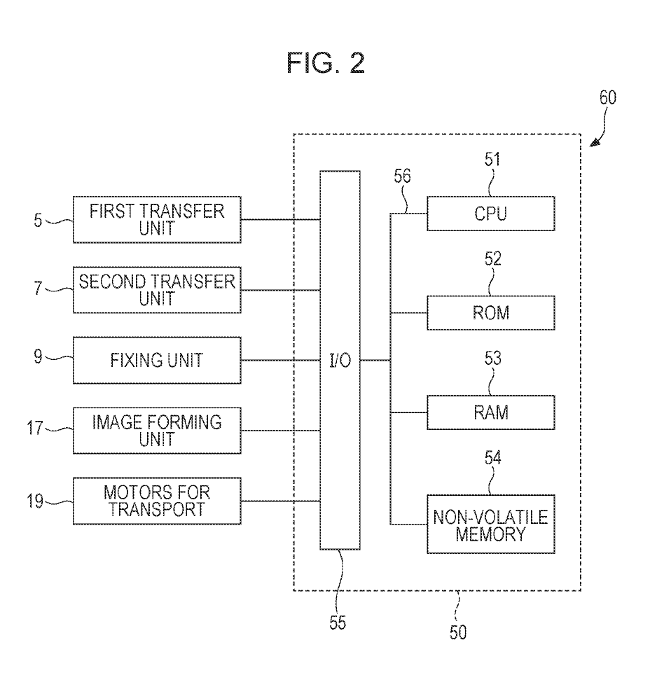

Next, a configuration of a substantial part of an electric system of the image forming apparatus 200 is described with reference to FIG. 2.

As illustrated in FIG. 2, the controller 60 of the image forming apparatus 200 is constituted, for example, by a computer 50. The computer 50 includes a central processing unit (CPU) 51, a read only memory (ROM) 52, a random access memory (RAM) 53, a non-volatile memory 54, and an input output interface (I/O) 55. The CPU 51, the ROM 52, the RAM 53, the non-volatile memory 54, and the I/O 55 are connected through a bus 56.

The first transfer units 5, the second transfer unit 7, the fixing unit 9, the image forming units 17 corresponding to respective colors of toner, and motors for transport 19 are connected to the I/O 55.

The motors for transport 19 include various rollers (e.g., the rollers 12A, 12D, and 12E) for transporting the intermediate transfer belt 6 and the motor that drives the sheet transfer roller 13 for transporting the sheet of paper P, and the like.

Note that devices connected to the I/O 55 are not limited to the devices illustrated in FIG. 2. For example, a communication device that is connected to a communication line such as the Internet and transmits and receives data to and from an external device connected to the communication line may be connected to the I/O 55.

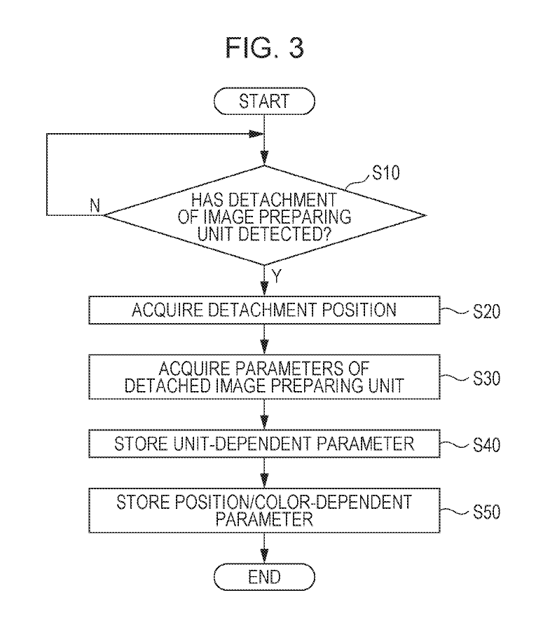

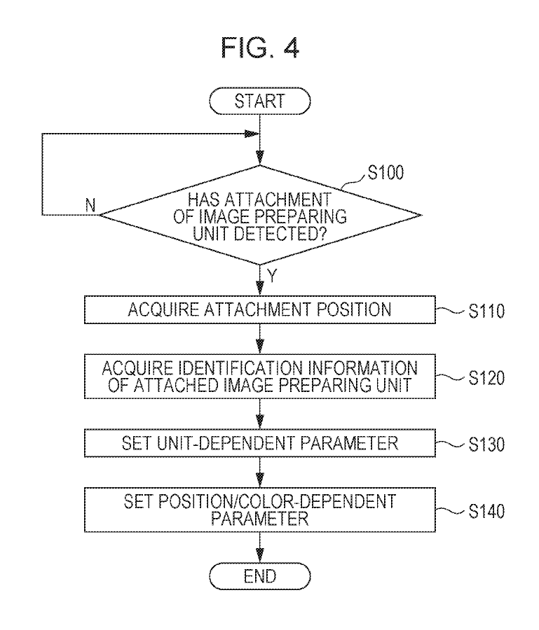

Next, how the image forming apparatus 200 acts in a case where an attachment position of any of the image preparing units 15 is changed is described with reference to FIGS. 3 and 4. FIG. 3 is a flowchart illustrating an example of a flow of a parameter storing process executed by the CPU 51 in a case where any of the image preparing units 15 in the image forming apparatus 200 is detached, for example, in order to change the attachment position of the image preparing unit 15.

An image formation program that defines the parameter storing process is stored in advance, for example, in the ROM 52. The CPU 51 loads the image formation program stored in the ROM 52 and thus executes the parameter storing process.

The following describes an example in which the image forming apparatus 200 includes at least one image forming unit 17 in which any of the image preparing units 15 is not attached and an attachment position of any of the image preparing units 15 that have been already attached to the image forming units 17 is changed to the image forming unit 17 in which no image preparing unit 15 is attached.

First, in Step S10, the CPU 51 detects whether or not any of the image preparing units 15 has been detached from any of the image forming units 17. Specifically, the CPU 51 detects whether or not any of the image preparing units 15 has been detached from any of the image forming units 17 on the basis of presence or absence of a detachment signal supplied from the image forming unit 17 when the image preparing unit 15 is detached.

In a case where the detachment signal is not supplied from any of the image forming units 17, the process in Step S10 is repeated. That is, the presence or absence of a detachment signal is monitored until any of the image preparing units 15 is detached from any of the image forming units 17.

Meanwhile, in a case where the CPU 51 detects supply of a detachment signal indicative of detachment of any of the image preparing units 15 from any of the image forming units 17, Step S20 is performed.

In Step S20, the CPU 51 acquires an attachment position from which the image preparing unit 15 has been detached by specifying the image forming unit 17 that has supplied the detachment signal indicative of detachment of the image preparing unit 15 and causes the acquired attachment position to be stored in the RAM 53. In order to specify the attachment position from the image preparing unit 15 has been detached on the basis of the image forming unit 17 that has supplied the detachment signal, it is only necessary to refer to, for example, correspondence information indicative of correspondences between the image forming units 17 and the attachment positions that is stored in advance in the non-volatile memory 54.

A region (image preparation parameter region) in which parameters of an attached image preparing unit are stored is provided in the RAM 53 in advance for each image forming unit 17. When the CPU 51 controls each of the image preparing units 15 to prepare an image on the photoconductor 1, the CPU 51 controls the image preparing unit 15 by referring to the parameters in the image preparation parameter region allocated to the image forming unit 17 including the image preparing unit 15 that prepares the image.

Therefore, in Step S30, the CPU 51 acquires parameters set for the image preparing unit 15 previously attached to the attachment position acquired in Step S20, i.e., parameters set for the detached image preparing unit 15.

In Step S40, the CPU 51 causes a unit-dependent parameter included in the parameters acquired in Step S30 to be stored, for example, in a unit-dependent parameter storage region provided in a predetermined region of the non-volatile memory 54.

Parameters set for each of the image preparing units 15 are described below. As has been described above, when the CPU 51 controls each of the image preparing units 15 to prepare an image, the image is prepared on the photoconductor 1 by referring to parameters set in the image preparation parameter region provided for the image preparing unit 15. The parameters referred to when the CPU 51 controls each of the image preparing units 15 to prepare an image are classified into two kinds of parameters.

One kind of parameter is a parameter determined on the basis of information determined by members accompanying each of the image preparing units 15 and is called a “unit-dependent parameter”. That is, the unit-dependent parameter is a parameter that is unique to each of the image preparing units 15 irrespective of the attachment position of the image preparing unit 15. That is, for example, even image preparing units 15 that prepare images of the same color are given different unit-dependent parameters as long as the image preparing units 15 are physically different.

The other kind of parameter is a parameter determined on the basis of a combination of an attachment position of each of the image preparing units 15 and a color of toner of the image preparing unit 15 and is called a “position/color-dependent parameter”. That is, even different image preparing units 15 are given an identical position/color-dependent parameter as long as these image preparing units 15 are the same in terms of attachment position and color of a prepared image.

The position/color-dependent parameter is an example of first setting information, and the unit-dependent parameter is an example of second setting information.

Specific examples of the unit-dependent parameter include attributes of toner such as a color and an average particle diameter of toner included in each of the image preparing units 15 and a correction amount of correction of difference between a concentration detected by the detection sensor 16 that detects a toner concentration and an actual toner concentration. Needless to say, the unit-dependent parameter is not limited to attributes of toner and a correction amount of a toner concentration. It is only necessary that the unit-dependent parameter includes at least one piece of information, such as a unit number represented by a serial number of each of the image preparing units 15, uniquely set for the image preparing unit 15 irrespective of the attachment position of the image preparing unit 15.

Specific examples of the position/color-dependent parameter include a control range of a potential difference (Vdeve) between a potential of a range (exposed part) of the photoconductor 1 exposed to light emitted from the laser output unit 3 and a developing bias applied when an electrostatic latent image is developed by the development roller 34. Furthermore, the position/color-dependent parameter includes a control range of a potential difference (Vcf) between a potential in a range (unexposed part) of the photoconductor 1 that has not been exposed to light emitted from the laser output unit 3 and a developing bias and a target density of an image on the intermediate transfer belt 6. Needless to say, the position/color-dependent parameter is not limited to the control range of Vdeve, the control range of Vcf, and the target density. It is only necessary that the position/color-dependent parameter include at least one parameter determined by a combination of an attachment position of each of the image preparing units 15 and a color of toner of the image preparing unit 15.

Vdeve is a voltage that determines an amount of toner supplied to the photoconductor 1. Since an amount of supplied toner becomes smaller as Vdeve becomes smaller, an amount of toner supplied from the image preparing unit 15 to the photoconductor 1 is adjusted by adjusting Vdeve. Vcf is called a cleaning field voltage. In a case where Vcf is smaller than a threshold value, an image defect called “fog” occurs, that is, toner remains in a range (blank part) other than an image prepared on the photoconductor 1. Meanwhile, in a case where Vcf is larger than the threshold value, an image defect such as a “carrier phenomenon” (also called Bead-Carry-Out “BCO”) occurs, that is, a carrier remains in a blank part of the photoconductor 1. Note that Vdeve and Vcf are not fixed values and change within a predetermined control range on the basis of various kinds of information.

The target density of an image on the intermediate transfer belt 6 is a parameter for correcting a density of a prepared image by adjusting a density of an image (patch) prepared for density adjustment on the intermediate transfer belt 6 to the target density. As the density of the patch transferred on the intermediate transfer belt 6 is deviated from the target density, a difference between an originally intended density of a user image and a density of a user image actually formed on the sheet of paper P becomes larger, and therefore an image defect occurs.

As for the control range of Vdeve, the control range of Vcf, and the target density, optimum values for suppressing occurrence of an image defect change depending on a combination of the attachment position of the image preparing unit 15 and a color of toner of the image preparing unit 15. A reason why these optimum values change depending on the attachment position of the image preparing unit 15 is that an order in which an image overlaps changes depending on the attachment position. The control range of Vdeve, the control range of Vcf, and the target density are set for the image preparing unit 15 in accordance with a combination of the attachment position of the image preparing unit 15 and a color of toner of the image preparing unit 15.

Among the parameters acquired in Step S30, the CPU 51 causes a unit-dependent parameter included in the acquired parameters to be stored in a unit-dependent parameter storage region corresponding to the detached image preparing unit 15 among the unit-dependent parameter storage regions provided for the respective image preparing units 15 by referring to identification information (e.g., a unit number of the image preparing unit 15) for uniquely identifying the image preparing unit 15.

In a case where only one image preparing unit 15 is provided for preparation of an image of each color, the image preparing unit 15 is uniquely identified on the basis of a color of toner of the image preparing unit 15. Therefore, in this case, a region in which a unit-dependent parameter is stored is uniquely determined by referring to the color of the toner of the image preparing unit 15. The identification information of each of the image preparing units 15 is not limited to the unit number of the image preparing unit 15. For example, the image preparing unit 15 may be identified on the basis of at least one of serial numbers of the developing unit 4 and the toner cartridge (not illustrated) accompanying the image preparing unit 15 and the serial number of the photoconductor 1 in a case where the photoconductor 1 is included in the image preparing unit 15 or a combination of these serial numbers.

In Step S50, the CPU 51 causes a position/color-dependent parameter among the parameters acquired in Step S30 to be stored in a position/color-dependent parameter storage region, for example, provided in a predetermined region of the non-volatile memory 54.

Specifically, the CPU 51 refers to information indicative of a color of toner of the image preparing unit 15 among the parameters acquired in Step S30. Then, the CPU 51 causes the position/color-dependent parameter included in the acquired parameters to be stored in a position/color-dependent parameter storage region corresponding to a combination of the original attachment position of the detached image preparing unit acquired in Step S20 and the color of the toner of the detached image preparing unit 15 among the position/color-dependent parameter storage regions provided for the respective combinations of attachment positions of the image preparing units 15 and colors of toner of the image preparing units 15.

In this way, the unit-dependent parameter set for the detached image preparing unit 15 is stored in the unit-dependent parameter storage region corresponding to the detached image preparing unit 15, and the position/color-dependent parameter set for the detached image preparing unit 15 is stored in the position/color-dependent parameter storage region corresponding to the combination of the original attachment position of the detached image preparing unit 15 and the color of the toner of the detached image preparing unit 15.

FIG. 4 is a flowchart illustrating an example of a flow of a parameter setting process executed by the CPU 51 in a case where the image preparing unit 15 detached from the image forming apparatus 200 in FIG. 3 is attached to an attachment position that is different from the original attachment position and is an attachment position of an image forming unit 17 in which any of the image preparing units 15 is not attached.

An image formation program that specifies the aforementioned parameter setting process is stored in advance, for example, in the ROM 52. The CPU 51 loads the image formation program stored in the ROM 52 and thus executes the parameter setting process.

First, in Step S100, the CPU 51 detects whether or not the image preparing unit 15 has been attached to the image forming unit 17. Specifically, the CPU 51 detects whether or not the image preparing unit 15 has been attached to the image forming unit 17 on the basis of presence or absence of an attachment signal supplied from the image forming unit 17 when the image preparing unit 15 is attached.

In a case where an attachment signal is not supplied from any of the image forming units 17, the process in Step S100 is repeated. That is, presence or absence of an attachment signal is monitored until the image preparing unit 15 is attached to any of the image forming units 17.

Meanwhile, in a case where an attachment signal indicative of attachment of the image preparing unit 15 supplied from any of the image forming units 17 is detected, Step S110 is performed.

In Step S110, the CPU 51 acquires an attachment position in which the image preparing unit 15 has been attached by specifying the image forming unit 17 that has supplied the attachment signal indicative of attachment of the image preparing unit 15 and then causes the acquired attachment position to be stored in the RAM 53. In order to specify the attachment position in which the image preparing unit 15 has been attached from the image forming unit 17 that has supplies an attachment signal, it is only necessary to refer to correspondence information indicative of correspondences between the image forming units 17 and attachment positions that are stored in advance, for example, in the non-volatile memory 54.

In Step S120, the CPU 51 acquires identification information for identifying the image preparing unit 15 that has been attached to the attachment position acquired in Step S110. The identification information for identifying the image preparing unit 15 is stored in advance, for example, in a storage device included in the image preparing unit 15, and in a case where the image preparing unit 15 has been attached to any of the attachment positions, the storage device included in the image preparing unit 15 is electrically connected to the CPU 51, and thus the identification information is acquired by the CPU 51.

In this step, for example, the CPU 51 acquires, as the identification information, the unit number of the image preparing unit 15 and the color of the toner of the image preparing unit 15. Note, however, that in a case where only one image preparing unit 15 is provided for preparation of an image of each color, each of the image preparing units 15 is identified on the basis of a color of toner of the image preparing unit 15, and therefore only the color of the toner of the image preparing unit 15 may be acquired as the identification information.

In Step S130, the CPU 51 uniquely identifies the attached image preparing unit 15 by using the identification information acquired in Step S120. Then, the CPU 51 reads out the unit-dependent parameter from the unit-dependent parameter storage region corresponding to the attached image preparing unit 15 and then sets the unit-dependent parameter in an image preparation parameter region allocated for the image forming unit 17 in the attachment position in which the image preparing unit 15 has been attached.

In Step S140, the CPU 51 reads out the position/color-dependent parameter from the position/color-dependent parameter storage region corresponding to the combination of the attachment position acquired in Step S110 and the color of the toner of the image preparing unit 15 included in the identification information acquired in Step S120 and then sets the position/color-dependent parameter in the image preparation parameter region allocated for the image forming unit 17 in the attachment position in which the image preparing unit 15 has been attached.

In this way, the unit-dependent parameter unique to the newly attached image preparing unit 15 is set for the image preparing unit 15. Furthermore, the position/color-dependent parameter corresponding to the combination of the attachment position of the newly attached image preparing unit 15 and the color of the toner of the image preparing unit 15 is set for the image preparing unit 15.

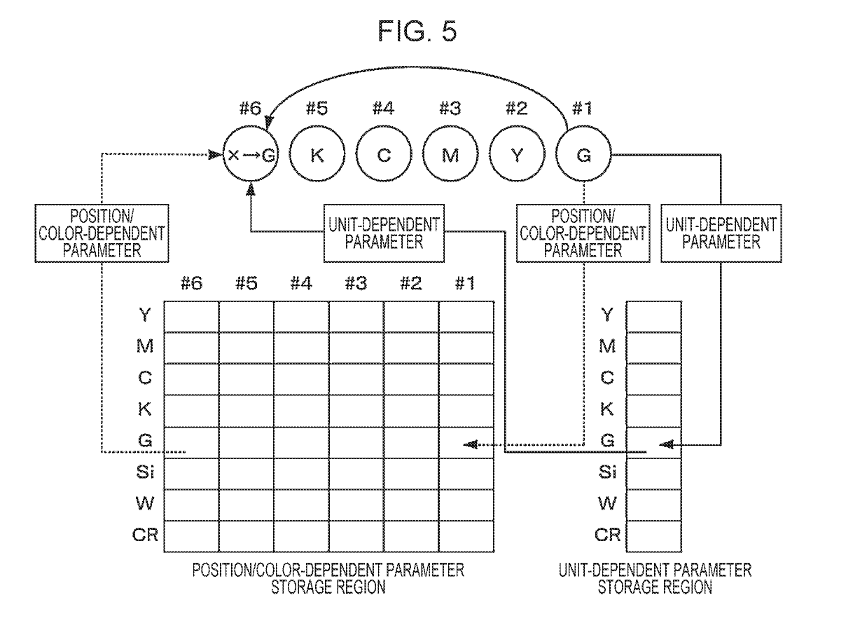

FIG. 5 is a view for explaining storage and setting of a unit-dependent parameter and a position/color-dependent parameter in a case where an attachment position of the image preparing unit 15G attached in the attachment position #1 is changed to the attachment position #6 in which any of the image preparing units 15 is not attached. The following describes an example in which only one image preparing unit 15 is provided for preparation of an image of each color. That is, each of the image preparing units 15 is uniquely identified on the basis of a color of toner of the image preparing unit 15.

As illustrated in FIG. 5, in a case where the image preparing unit 15G is detached from the attachment position #1, a detachment position of the image preparing unit 15 is acquired as “#1” in Step S20 of FIG. 3. Furthermore, a color of toner of the detached image preparing unit 15 is acquired as “G” from the parameters acquired in Step S30 of FIG. 3.

Accordingly, a unit-dependent parameter set for the detached image preparing unit 15G is stored in a unit-dependent parameter storage region corresponding to the toner color G in Step S40 of FIG. 3. Furthermore, a position/color-dependent parameter set for the detached image preparing unit 15G is stored in a position/color-dependent parameter storage region corresponding to a combination of the toner color G and the attachment position #1 in Step S50 of FIG. 3.

In a case where the image preparing unit 15G detached from the attachment position #1 is attached to the attachment position #6, the attachment position of the image preparing unit 15G is acquired as “#6” in Step S110 of FIG. 4. Furthermore, a color of toner of the image preparing unit 15 attached to the attachment position #6 is acquired as “G” from the identification information of the image preparing unit 15G acquired in Step S120 of FIG. 4.

Accordingly, a unit-dependent parameter that is the same as the unit-dependent parameter set for the image preparing unit 15G before change of the attachment position (in the attachment position #1) is set for the image preparing unit 15G after the change of the attachment position (in the attachment position #6) in Step S130 of FIG. 4. Furthermore, a position/color-dependent parameter corresponding to a combination of the toner G and the attachment position #6 that is an attachment position after the change of the attachment position is read out from a position/color-dependent parameter storage region and is set for the image preparing unit 15G that has been attached to the attachment position #6 in Step S140 of FIG. 4.

If an attachment position of any of the image preparing units 15 is changed and if parameters are set for the image preparing unit 15 after the change of the attachment position on the basis of only an attachment position of the image preparing unit 15, a unit-dependent parameter is not set for the image preparing unit 15 after the change of the attachment position. Furthermore, in a case where parameters are set for the image preparing unit 15 after the change of the attachment position on the basis of only the attachment position of the image preparing unit 15, the same parameter is always set for the image preparing unit 15 of the same attachment position irrespective of a color of toner of the attached image preparing unit 15.

Meanwhile, in the image forming apparatus 200 according to the present exemplary embodiment, in a case where an attachment position of any of image preparing units 15 is changed, a unit-dependent parameter that is a parameter unique to the image preparing unit 15 and a position/color-dependent parameter determined on the basis of a combination of the attachment position of the image preparing unit 15 and a color of toner of the image preparing unit 15 are set for the image preparing unit 15 after the change of the attachment position. That is, the CPU 51 adjusts, for example, a correction amount of a toner concentration detected by the detection sensor 16 unique to the image preparing unit 15 in accordance with the unit-dependent parameter and adjusts, for example, a toner concentration, Vdeve, Vcf, and the like concerning preparation of an image in accordance with the position/color-dependent parameter. It is therefore possible to suppress occurrence of an image defect of an image prepared by the image preparing units 15 more than a case where parameters are set for the image preparing unit 15 after change of an attachment position on the basis of only the attachment position of the image preparing unit 15.

### Second Exemplary Embodiment

In the first exemplary embodiment, how the image forming apparatus 200 acts in a case where an attachment position of any of the image preparing units 15 is changed has been described. Although the second exemplary embodiment is the same as the first exemplary embodiment in that an attachment position of any of image preparing units 15 is changed, how the image forming apparatus 200 acts in a case where attachment positions of image preparing units 15 that are attached in different attachment positions and form images of the same color are changed is described in the second exemplary embodiment.

An example of a configuration of a substantial part of a structure and an example of a configuration of a substantial part of an electric system of an image forming apparatus 200 according to the second exemplary embodiment are identical to the examples of the configurations of the substantial parts illustrated in FIGS. 1 and 2 except for colors of toner of the image preparing units 15 attached in attachment positions #1 through #6.

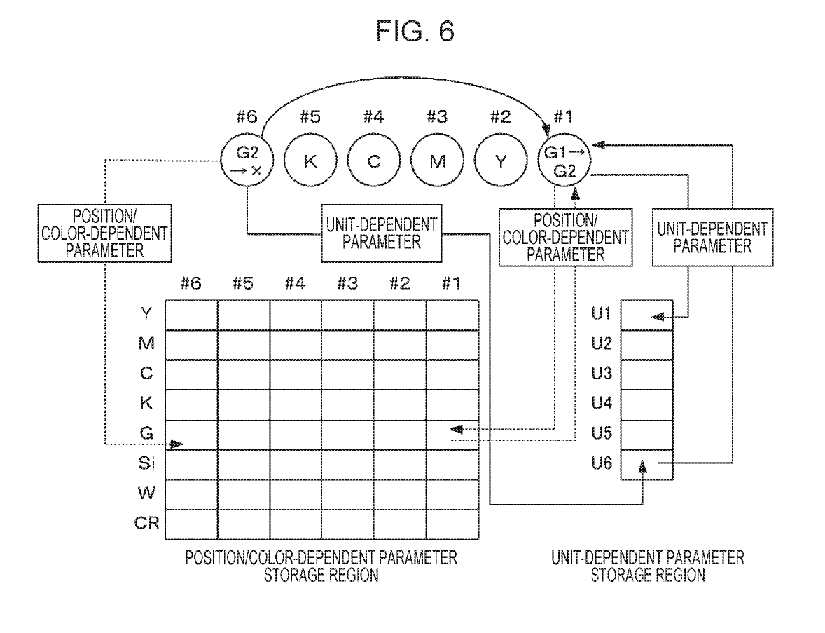

FIG. 6 illustrates an example of attachment of the image preparing units 15 of the image forming apparatus 200 according to the second exemplary embodiment. As illustrated in FIG. 6, it is assumed that an image preparing unit 15G, an image preparing unit 15Y, an image preparing unit 15M, an image preparing unit 15C, an image preparing unit 15K, and an image preparing unit 15G are attached to the attachment position #1, the attachment position #2, the attachment position #3, the attachment position #4, the attachment position #5, and the attachment position #6 of the image forming apparatus 200, respectively. Since the image preparing units 15G of the toner color G are attached in the attachment position #1 and the attachment position #6, the image preparing unit 15G attached in the attachment position #1 is referred to as an “image preparing unit 15G1”, and the image preparing unit 15G attached in the attachment position #6 is referred to as an “image preparing unit 15G2” in a case where these image preparing units 15G need be distinguished from each other.

Since plural image preparing units 15 prepare images of an identical color in the image forming apparatus 200 according to the second exemplary embodiment, unit-dependent parameter storage regions are provided, for example, for respective unit numbers of the image preparing units 15. For convenience of description, a unit number of the image preparing unit 15G1, a unit number of the image preparing unit 15Y, a unit number of the image preparing unit 15M, a unit number of the image preparing unit 15C, a unit number of the image preparing unit 15K, and a unit number of the image preparing unit 15G2 are referred to as “U1”, “U2”, “U3”, “U4”, “U5”, and “U6”, respectively.

The following describes an example in which attachment positions of image preparing units 15 that are attached in different attachment positions and prepare images of an identical color are changed by taking, as an example, a case where the image preparing unit 15G1 attached in the attachment position #1 is detached and the image preparing unit 15G2 attached in the attachment position #6 is attached in the attachment position #1 with reference to FIG. 6.

First, in a case where the image preparing unit 15G1 is detached from the attachment position #1, an image formation program specifying the parameter storing process illustrated in FIG. 3 is executed by a CPU 51.

Accordingly, a detachment position of the image preparing unit 15 is acquired as “#1” in Step S20 of FIG. 3. Furthermore, identification information of the detached image preparing unit 15 is acquired from the parameters acquired in Step S30 of FIG. 3. Specifically, a color (“G” in this case) of the detached image preparing unit 15 and a unit number (“U1” in this case) of the image preparing unit 15 are acquired.

Accordingly, a unit-dependent parameter set for the detached image preparing unit 15G1 is stored in a unit-dependent parameter storage region corresponding to the unit number U1 in Step S40 of FIG. 3. Furthermore, a position/color-dependent parameter set for the detached image preparing unit 15G1 is stored in a position/color-dependent parameter storage region corresponding to the toner color G and the attachment position #1 in Step S50 of FIG. 3.

Furthermore, an image formation program that specifies the parameter storing process illustrated in FIG. 3 is executed by the CPU 51 also in a case where the image preparing unit 15G2 is detached from the attachment position #6. Accordingly, a unit-dependent parameter set for the detached image preparing unit 15G2 is stored in a unit-dependent parameter storage region corresponding to the unit number U6 in Step S40 of FIG. 3, as in the case where the image preparing unit 15G1 is detached from the attachment position #1. Furthermore, a position/color-dependent parameter set for the detached image preparing unit 15G2 is stored in a position/color-dependent parameter storage region corresponding to a combination of the toner color G and the attachment position #6 in Step S50 of FIG. 3.

In a case where the image preparing unit 15G2 detached from the attachment position #6 is attached in the attachment position #1, an image formation program that specifies the parameter setting process illustrated in FIG. 4 is executed by the CPU 51.

Specifically, the attachment position of the image preparing unit 15G2 is acquired as “#1” in Step S110 of FIG. 4. Furthermore, a color of toner of the image preparing unit 15 attached to the attachment position #1 is acquired as “G”, and a unit number of the attached image preparing unit 15 is acquired as “U6” from the identification information of the image preparing unit 15G acquired in Step S120 of FIG. 4.

Accordingly, a unit-dependent parameter different from a unit-dependent parameter set for the image preparing unit 15G1 in a case where the image preparing unit 15G1 is attached to the attachment position #1 is set for the image preparing unit 15G2 that has been attached to the attachment position #1 in Step S130 of FIG. 4. Furthermore, even in a case where the image preparing unit 15 attached to the attachment position #1 is changed from the image preparing unit 15G1 to the image preparing unit 15G2, a color of toner of the image preparing unit 15 attached to the attachment position #1 is not changed by the change of the image preparing unit 15. Accordingly, a position/color-dependent parameter that is identical to a position/color-dependent parameter set in a case where the image preparing unit 15G1 is attached to the attachment position #1 is set for the image preparing unit 15G2 that has been newly attached to the attachment position #1 in Step S140 of FIG. 4.

As described above, according to the image forming apparatus 200 according to the second exemplary embodiment, even in a case where an image preparing unit 15 in any of the image forming units 17 is replaced by another image preparing unit 15 that prepares an image of the same color, a unit-dependent parameter unique to the replacing image preparing unit 15. This suppresses occurrence of an image defect in an image prepared by the image preparing units 15 more than a case where parameters are set for the image preparing unit 15 after change of an attachment position on the basis of only the attachment position of the image preparing unit 15.

### Third Exemplary Embodiment

In the image forming apparatuses 200 according to the first exemplary embodiment and the second exemplary embodiment, any of the image preparing units 15 that have been already attached is detached from the image forming apparatus 200, and an attachment position of the detached image preparing unit 15 is changed. In the third exemplary embodiment, how an image forming apparatus 200 acts in a case where any of image preparing units 15 that have been attached to the image forming apparatus 200 is replaced by another image preparing unit 15 that has not been attached to the image forming apparatus 200 is described.

An example of a configuration of a substantial part of a structure and an example of a configuration of an electric system of the image forming apparatus 200 according to the third exemplary embodiment are identical to those illustrated in FIGS. 1 and 2.

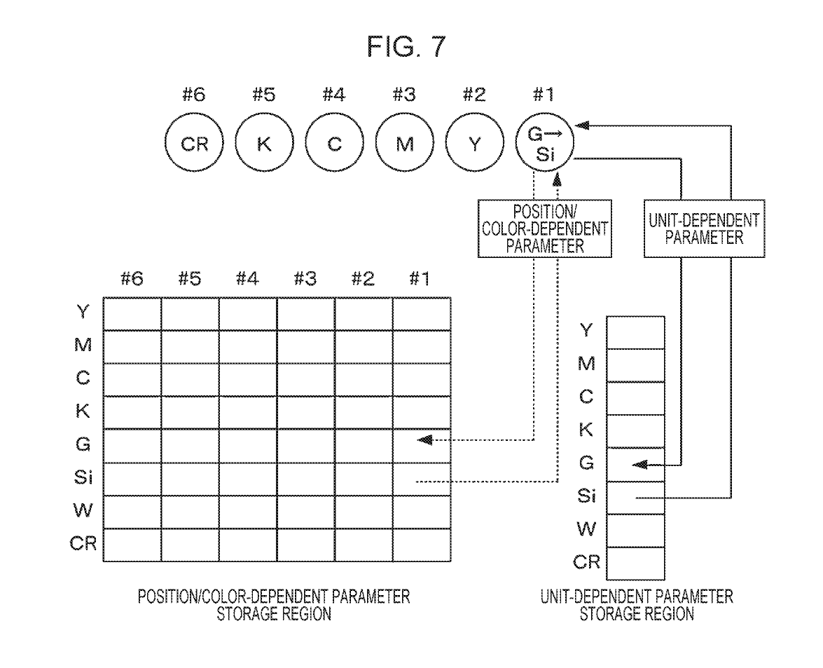

FIG. 7 illustrates an example of attachment of the image preparing units 15 of the image forming apparatus 200 according to the third exemplary embodiment. As illustrated in FIG. 7, an image preparing unit 15G, an image preparing unit 15Y, an image preparing unit 15M, an image preparing unit 15C, an image preparing unit 15K, and an image preparing unit 15CR are attached to an attachment position #1, an attachment position #2, an attachment position #3, an attachment position #4, an attachment position #5, and an attachment position #6 of the image forming apparatus 200, respectively. For convenience of description, it is assumed that only one image preparing unit 15 is provided for preparation of an image of each color. Therefore, each of the image preparing units 15 is uniquely identified as long as a color of toner of the image preparing unit 15 is known as identification information.

The following describes an example in which the image preparing unit 15G attached to the attachment position #1 is detached and is replaced by an image preparing unit 15Si for preparing an image of a Si color that is stored in a separate place with reference to FIG. 7.

First, in a case where the image preparing unit 15G is detached from the attachment position #1, an image formation program that specifies the parameter storing process illustrated in FIG. 3 is executed by a CPU 51.

Therefore, in Step S20 of FIG. 3, a detachment position of the image preparing unit 15 is acquired as “#1”. Furthermore, identification information of the detached image preparing unit 15 is acquired from the parameters acquired in Step S30 of FIG. 30. Specifically, a color (“G” in this case) of toner of the detached image preparing unit 15 is acquired.

Accordingly, a unit-dependent parameter set for the detached image preparing unit 15G is stored in a unit-dependent parameter storage region corresponding to the toner color G in Step S40 of FIG. 3. Furthermore, a position/color-dependent parameter set for the detached image preparing unit 15G is stored in a position/color-dependent parameter storage region corresponding to a combination of the toner color G and the attachment position #1 in Step S50 of FIG. 3.

In a case where the image preparing unit 15Si is attached to the attachment position #1 in replacement of the image preparing unit 15G, an image formation program that specifies the parameter setting process illustrated in FIG. 4 is executed by the CPU 51.

Specifically, the attachment position of the attached image preparing unit 15Si is acquired as “#1” in Step S110 of FIG. 4. Furthermore, a color of toner of the image preparing unit 15 attached to the attachment position #1 is acquired as “Si” from the identification information of the image preparing unit 15 acquired in Step S120 of FIG. 4.

In this case, the image preparing unit 15 itself attached to the attachment position #1 is changed, and a color of an image prepared by the image preparing unit 15 attached to the attachment position #1 is also changed.

Accordingly, a unit-dependent parameter corresponding to the image preparing unit 15Si that is different from a unit-dependent parameter set for the detached image preparing unit 15G is set for the attached image preparing unit 15Si in Step S130 of FIG. 4. Furthermore, a position/color-dependent parameter that is different from a position/color-dependent parameter set for the detached image preparing unit 15G and that corresponds to a combination of the toner color Si and the attachment position #1 is set for the detached image preparing unit 15Si in Step S140 of FIG. 4.

Although an example in which the image preparing unit 15G is replaced by the image preparing unit 15Si for preparing an image of a different color has been illustrated in FIG. 7, the image preparing unit 15G may be replaced by another image preparing unit 15 for preparing an image of the same color. In this case, a position/color-dependent parameter set before replacement of the image preparing unit 15 is identical to a position/color-dependent parameter set after the replacement of the image preparing unit 15, but a unit-dependent parameter set before replacement of the image preparing unit 15 is different from a unit-dependent parameter set after the replacement of the image preparing unit 15 since the image preparing units 15 themselves are different.

As described above, according to the image forming apparatus 200 according to the third exemplary embodiment, even in a case where any of the image preparing units 15 that have been already attached to the image forming apparatus 200 is replaced by another image preparing unit 15 that has not been attached to the image forming apparatus 200, a proper unit-dependent parameter and a proper position/color-dependent parameter are set for the replacing image preparing unit 15. This suppresses occurrence of an image defect in an image prepared by the image preparing units 15 more than a case where parameters are set for a replacing image preparing unit 15 on the basis of only an attachment position of the image preparing unit 15.

The disclosed technique has been described above by using the exemplary embodiments, but the disclosed technique is not limited to the scope described in the exemplary embodiments. The exemplary embodiments may be changed or modified in various ways without departing from the spirit of the disclosure, and the changes or the modifications are also encompassed within the technical scope of the disclosure. For example, the order of processes may be changed without departing from the spirit of the disclosure.

Although how the image forming apparatus 200 according to the disclosure that is an electrophotographic image forming apparatus acts has been described in the exemplary embodiments, the present invention may be applied, for example, to an inkjet image forming apparatus. Furthermore, the present invention may be applied not only to an intermediate transfer type image forming apparatus 200 in which images transferred onto the intermediate transfer belt 6 by the first transfer units 5 are transferred again onto the sheet of paper P by the second transfer unit 7, but also to a direct transfer type image forming apparatus in which images prepared on the photoconductors 1 are directly transferred onto the sheet of paper P. Furthermore, the present invention may be applied to a rotary development type image forming apparatus in which images are prepared on a common photoconductor 1 while switching image preparing units 15 for respective colors.

Although an aspect in which the parameter storing process and the parameter setting process in the controller 60 are accomplished by software has been described as an example in the exemplary embodiments, for example, processes equivalent to those in the flowcharts illustrated in FIGS. 3 and 4 may be performed by hardware. This speeds up the processes as compared with a case where the processes in the controller 60 are accomplished by software.

Although an aspect in which the image formation program is installed in the ROM 52 has been described in the above exemplary embodiments, the present invention is not limited to this. The image formation program according to the present invention may be offered in a form recorded on a computer-readable recording medium. For example, the image formation program according to the present invention may be offered in a form recorded on an optical disc such as a compact disc (CD)-ROM or a digital versatile disc (DVD)-ROM. Alternatively, the image formation program according to the present invention may be offered in a form recorded on a semiconductor memory such as a USB memory or a flash memory. Furthermore, in a case where a communication device is connected to the image forming apparatus 200, the image formation program according to the present invention may be acquired from an external device through a communication line.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a plurality of image preparing units whose attachment positions are selectable and that prepare images of respective colors; and
a setting unit that, in a case where an attachment position of a first image preparing unit, which is any one of the plurality of image preparing units, is changed from a first attachment position to a second attachment position different from the first attachment position, sets, for the first image preparing unit in the second attachment position, first setting information that is different from first setting information set for the first image preparing unit while the first image preparing unit is attached in the first attachment position and second setting information that is identical to second setting information set for the first image preparing unit while the first image preparing unit is attached to the first attachment position.

2. An image forming apparatus comprising:
a plurality of image preparing units whose attachment positions are selectable and that prepare images of respective colors; and
a setting unit that, in a case where an image preparing unit attached to a first attachment position among the attachment positions is changed from a first image preparing unit to a second image preparing unit that is attached to a second attachment position different from the first attachment position and that is an image preparing unit for a color identical to a color of the first image preparing unit, sets, for the second image preparing unit, first setting information that is identical to first setting information set for the first image preparing unit while the first image preparing unit is attached to the first attachment position and second setting information that is different from second setting information set for the first image preparing unit while the first image preparing unit is attached to the first attachment position.

3. The image forming apparatus according to claim 1, wherein
the first setting information is information determined by a combination of an attachment position of each of the image preparing units and a color of an image prepared by the image preparing unit.

4. The image forming apparatus according to claim 2, wherein
the first setting information is information determined by a combination of an attachment position of each of the image preparing units and a color of an image prepared by the image preparing unit.

5. The image forming apparatus according to claim 3, wherein
each of the image preparing units prepares an image by using an electrophotographic system for obtaining an image by developing an electrostatic latent image formed by exposure of a photoconductor to light by using toner; and
the first setting information includes at least one of a control range of a potential difference between a potential of an exposed part of the photoconductor and a developing potential used for development of the electrostatic latent image, a control range of a potential difference between a potential of an unexposed part of the photoconductor and the developing potential, and a target density of the prepared image.

6. The image forming apparatus according to claim 4, wherein
each of the image preparing units prepares an image by using an electrophotographic system for obtaining an image by developing an electrostatic latent image formed by exposure of a photoconductor to light by using toner; and
the first setting information includes at least one of a control range of a potential difference between a potential of an exposed part of the photoconductor and a developing potential used for development of the electrostatic latent image, a control range of a potential difference between a potential of an unexposed part of the photoconductor and the developing potential, and a target density of the prepared image.

7. The image forming apparatus according to claim 1, wherein
the second setting information is information determined by a member accompanying each of the image preparing units irrespective of an attachment position of the image preparing unit.

8. The image forming apparatus according to claim 2, wherein
the second setting information is information determined by a member accompanying each of the image preparing units irrespective of an attachment position of the image preparing unit.

9. The image forming apparatus according to claim 7, further comprising, as the member accompanying the image preparing unit that determines the second setting information, a detection sensor that detects toner used for preparation of an image and a toner concentration.

10. The image forming apparatus according to claim 8, further comprising, as the member accompanying the image preparing unit that determines the second setting information, a detection sensor that detects toner used for preparation of an image and a toner concentration.

11. The image forming apparatus according to claim 1, wherein
the plurality of image preparing units include an image preparing unit that prepares an image by using chromatic toner that contains no metallic pigment and an image preparing unit that prepares an image by using spot-color toner that is any of white toner, clear toner, and toner that contains a metallic pigment.

12. The image forming apparatus according to claim 2, wherein
the plurality of image preparing units include an image preparing unit that prepares an image by using chromatic toner that contains no metallic pigment and an image preparing unit that prepares an image by using spot-color toner that is any of white toner, clear toner, and toner that contains a metallic pigment.

13. A non-transitory computer readable medium storing a program causing a computer to function as the setting unit of the image forming apparatus as set forth in claim 1.
